(19) United States
(12) Patent Application Publication
(10) Pub. No.: US 2025/0148374 A1
(43) Pub. Date: May 8, 2025

(54) ELECTRONIC DEVICE AND CONTROL METHOD THEREOF

(71) Applicant: Samsung Electronics Co., Ltd., Suwon-si (KR)

(72) Inventors: Yongkweon JEON, Suwon-si (KR); Chungman LEE, Suwon-si (KR); Hoyoung KIM, Suwon-si (KR)

(21) Appl. No.: 19/012,155

(22) Filed: Jan. 7, 2025

Related U.S. Application Data
(63) Continuation of application No. PCT/KR2023/012649, filed on Aug. 25, 2023.

(30) Foreign Application Priority Data
Oct. 17, 2022 (KR) 10-2022-0133532
Jan. 26, 2023 (KR) 10-2023-0010313

(51) Int. Cl. G06N 20/00; G06N 3/0464

(52) U.S. Cl. CPC G06N 20/00; G06N 3/0464

(57) ABSTRACT

An electronic device is provided. The electronic device includes memory storing a learning module comprising a first generator that generates an input vector, a second generator that generates synthetic data, a first learning model that analyzes the synthetic data and one or more computer programs, and one or more processors communicatively coupled to the memory, wherein the one or more computer programs include computer-executable instructions that, when executed by the one or more processors individually or collectively, cause the electronic device to obtain the input vector from the first generator, obtain the synthetic data corresponding to the input vector through inputting the input vector into the second generator, obtain output data by analyzing the synthetic data by inputting the synthetic data into the first learning model, and learn, at least one parameter included in the first generator and at least one parameter included in the second generator on the basis of the output data.

### CROSS-REFERENCE TO RELATED APPLICATION(S)

This application is a continuation application, claiming priority under 35 U.S.C. § 365 (c), of an International application No. PCT/KR2023/012649, filed on Aug. 25, 2023, which is based on and claims the benefit of a Korean patent application number 10-2022-0133532, filed on Oct. 17, 2022, in the Korean Intellectual Property Office, and of a Korean patent application number 10-2023-0010313, filed on Jan. 26, 2023, in the Korean Intellectual Property Office, the disclosure of each of which is incorporated by reference herein in its entirety.

### BACKGROUND

### 1. Field

The disclosure relates to an electronic device and a control method thereof. More particularly, the disclosure relates to an electronic device for training an artificial intelligence model by using synthetic data, and a control method thereof.

### 2. Description of Related Art

A generator may generate virtual data on the basis of an input vector. The virtual data may indicate data generated by the generator rather than real data. If the real data is not available, an artificial intelligence (AI) network may be trained using the virtual data.

The virtual data may be used if a learning operation using the real data is not available due to security or cost issues. However, if the virtual data is used, learning accuracy may be lower than in a case where the real data is used.

In addition, if the learning operation is performed using the virtual data, information loss may occur depending on a stride size, and learning performance may deteriorate.

In addition, using the virtual data may increase a storage size of the pre-learning model used in the AI network, making it difficult to use on a terminal device (for example, a mobile device).

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device that learns a parameter related to a first generator and a parameter related to a second generator through a learning module including the first generator that generates an input vector, the second generator that generates synthetic data, and a first learning model that analyzes the synthetic data, and a control method thereof.

Additional aspects will be set forth in part in the description which follows and, in part, will be apparent from the description, or may be learned by practice of the presented embodiments.

In accordance with an aspect of the disclosure, an electronic device is provided. The electronic device includes memory storing a learning module including a first generator that generates an input vector, a second generator that generates synthetic data, a first learning model that analyzes the synthetic data and one or more computer programs, and one or more processors communicatively coupled to the memory, wherein the one or more computer programs include computer-executable instructions that, when executed by the one or more processors individually or collectively, cause the electronic device to obtain the input vector from the first generator, obtain the synthetic data corresponding to the input vector by inputting the input vector into the second generator, obtain output data generated by analyzing the synthetic data through inputting the synthetic data into the first learning model, and learn at least one parameter included in the first generator and at least one parameter included in the second generator on the basis of the output data.

The one or more computer programs further include computer-executable instructions that, when executed by one or more processors individually or collectively, cause the electronic device to obtain a loss value on the basis of the output data, and learn the at least one parameter included in the first generator and the at least one parameter included in the second generator to minimize the loss value.

The output data includes statistical feature data of the synthetic data.

The output data includes the mean value and standard deviation value of the synthetic data, and the one or more computer programs further include computer-executable instructions that, when executed by one or more processors individually or collectively, cause the electronic device to obtain a first difference value between the mean value of the synthetic data and a mean value of a batch normalization (BN) layer included in the first learning model, obtain a second difference value between the standard deviation value of the synthetic data and a standard deviation value of the batch normalization (BN) layer included in the first learning model, and obtain the loss value on the basis of the first difference value and the second difference value.

The one or more computer programs further include computer-executable instructions that, when executed by one or more processors individually or collectively, cause the electronic device to obtain stride data of at least one convolutional layer included in the first learning model, and replace an identified convolutional layer with a swing convolution layer if the convolutional layer having a stride data size of 2 or more is identified among the at least one convolutional layer, and the swing convolution layer may be a convolutional layer that randomly selects a computation object on the basis of padding data.

The swing convolution layer is a layer that includes an operation for obtaining second data by adding the padding data to first data if the first data is input thereinto, an operation for obtaining third data by selecting some data regions from the second data on the basis of a size of the first data, and an operation for performing convolution computation on the basis of the third data and kernel data of the identified convolutional layer.

The first generator is a generator that generates a latent vector on the basis of at least one parameter, and the at least one parameter included in the first generator is a parameter used to generate the synthetic data related to a target set by a user.

The synthetic data is image data related to a target set by a user.

The one or more computer programs further include computer-executable instructions that, when executed by one or more processors individually or collectively, cause the electronic device to obtain a second learning model by quantizing the first learning model, and the second learning model is a compressed model of the first learning model.

The device further includes a communication interface, wherein the one or more computer programs further include computer-executable instructions that, when executed by one or more processors individually or collectively, cause the electronic device to transmit the second learning model to an external device through the communication interface.

In accordance with another aspect of the disclosure, a method performed by an electronic device, which stores a learning module including a first generator that generates an input vector, a second generator that generates synthetic data, and a first learning model that analyzes the synthetic data is provided. The control method includes obtaining, by the electronic device, the input vector from the first generator, obtaining, by the electronic device, the synthetic data corresponding to the input vector by inputting the input vector into the second generator, obtaining, by the electronic device, output data generated by analyzing the synthetic data through inputting the synthetic data into the first learning model, and learning, by the electronic device, at least one parameter included in the first generator and at least one parameter included in the second generator on the basis of the output data.

In the learning, a loss value is obtained on the basis of the output data, and the at least one parameter included in the first generator and the at least one parameter included in the second generator is learned to minimize the loss value.

The output data includes statistical feature data of the synthetic data.

The output data includes the mean value and standard deviation value of the synthetic data, and in the obtaining of the loss value, a first difference value between the mean value of the synthetic data and a mean value of a batch normalization (BN) layer included in the first learning model is obtained, a second difference value between the standard deviation value of the synthetic data and a standard deviation value of the batch normalization (BN) layer included in the first learning model is obtained, and the loss value is obtained on the basis of the first difference value and the second difference value.

The method further includes obtaining stride data of at least one convolutional layer included in the first learning model and replacing an identified convolutional layer with a swing convolution layer if the convolutional layer having a stride data size of 2 or more is identified among the at least one convolutional layer, wherein the swing convolution layer is a convolutional layer that randomly selects a computation object on the basis of padding data.

The swing convolution layer is a layer that includes an operation for obtaining second data by adding the padding data to first data if the first data is input thereinto, an operation for obtaining third data by selecting some data regions from second data on the basis of a size of the first data, and an operation for performing convolution computation on the basis of the third data and kernel data of the identified convolutional layer.

The first generator is a generator that generates a latent vector on the basis of at least one parameter, and at least one parameter included in the first generator is a parameter used to generate the synthetic data related to a target set by a user.

The synthetic data may is image data related to a target set by a user.

The control method further includes obtaining a second learning model by quantizing the first learning model, and the second learning model is a compressed model of the first learning model.

The control method further includes transmitting the second learning model to an external device.

In accordance with an aspect of the disclosure, one or more non-transitory computer-readable storage media storing a learning module including a first generator that generates an input vector, a second generator that generates synthetic data, a first learning model that analyzes the synthetic data and one or more computer programs including computer-executable instructions that, when executed by one or more processors of an electronic device individually or collectively, cause the electronic device to perform operations are provided. The operations include obtaining, by the electronic device, the input vector from the first generator, obtaining, by the electronic device, the synthetic data corresponding to the input vector by inputting the input vector into the second generator, obtaining, by the electronic device, output data generated by analyzing the synthetic data through inputting the synthetic data into the first learning model, and learning, by the electronic device, at least one parameter included in the first generator and at least one parameter included in the second generator on the basis of the output data.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram for describing a system including an electronic device and an external device according to an embodiment of the disclosure;

FIG. 2 is a block diagram showing a configuration included in the electronic device according to an embodiment of the disclosure;

FIG. 3 is a block diagram showing a configuration included in an external device according to an embodiment of the disclosure;

FIG. 4 is a diagram for describing a learning module and a compression module according to an embodiment of the disclosure;

FIG. 5 is a diagram for describing an operation performed by a learning module according to an embodiment of the disclosure;

FIG. 6 is a diagram for specifically describing an operation performed by a learning module according to an embodiment of the disclosure;

FIG. 7 is a diagram for describing forward propagation and back propagation processes performed by a learning module according to an embodiment of the disclosure;

FIG. 8 is a diagram for describing convolution computation and transposed convolution computation according to an embodiment of the disclosure;

FIG. 9 is a diagram for describing a learning operation performed by a learning module according to an embodiment of the disclosure;

FIG. 10 is a diagram for describing an operation for modifying a first learning model according to an embodiment of the disclosure;

FIG. 11 is a diagram for describing an operation of selecting a computation target by using a swing convolution layer according to an embodiment of the disclosure;

FIG. 12 is a diagram for describing an operation of performing computation on a computation target by using a swing convolution layer according to an embodiment of the disclosure;

FIG. 13 is a flowchart for describing a learning operation of a learning module according to an embodiment of the disclosure;

FIG. 14 is a flowchart for specifically describing a learning operation of a learning module according to an embodiment of the disclosure;

FIG. 15 is a flowchart for describing an operation of replacing a specific convolution layer with a swing convolution layer according to an embodiment of the disclosure;

FIG. 16 is a diagram for describing a quantization process according to an embodiment of the disclosure;

FIG. 17 is a diagram for describing a compression operation in a quantization process according to an embodiment of the disclosure;

FIG. 18 is a diagram for describing a learning operation performed by a compression module according to an embodiment of the disclosure;

FIG. 19 is a flowchart for describing an operation of transmitting a second learning model to an external device according to an embodiment of the disclosure;

FIG. 20 is a diagram for describing a screen related to a virtual image generation program according to an embodiment of the disclosure;

FIG. 21 is a flow chart for describing a learning operation of a learning module according to an embodiment of the disclosure;

FIG. 22 is a flow chart for describing a learning operation of a compression module according to an embodiment of the disclosure; and

FIG. 23 is a diagram for describing a control method of an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the specification, an expression “have”, “may have”, “include”, “may include”, or the like, indicates the existence of a corresponding feature (for example, a numerical value, a function, an operation, or a component such as a part), and does not exclude the existence of an additional feature.

An expression, “at least one of A or/and B” may indicate either “A or B”, or “both of A and B”.

Expressions “first”, “second”, and the like used in the disclosure may qualify various components regardless of their sequence or importance. These expressions are used only to distinguish one component from another component, and do not limit the corresponding components.

If any component (for example, a first component) is described as being “(operatively or communicatively) coupled with/to or connected to” another component (for example, a second component), it should be understood that any component may be directly coupled to another component or may be coupled to another component through still another component (for example, a third component).

It should be understood that a term “include”, “formed of”, or the like used in this application specifies the existence of features, numerals, steps, operations, components, parts, or combinations thereof mentioned in the specification and does not preclude the existence or addition of one or more other features, numerals, steps, operations, components, parts, or combinations thereof.

In the disclosure, a “module” or a “˜er/˜or” may perform at least one function or operation, and be implemented by hardware, software, or a combination of hardware and software. In addition, a plurality of “modules” or a plurality of “˜ers/˜ors” may be integrated in at least one module and implemented by at least one processor (not shown) except for a “module” or a “˜er/or” that needs to be implemented by specific hardware.

In the specification, a term “user” may refer to a person using an electronic device or a device using the electronic device (e.g., artificial intelligence electronic device).

In the disclosure, an artificial intelligence model being trained indicates that a basic artificial intelligence model (e.g., the artificial intelligence model including any random parameter) is trained using a large number of learning data based on a learning algorithm, thereby generating a predefined operation regulation or the artificial intelligence model, set to perform a desired feature (or purpose). The learning may be conducted through a separate server and/or system, is not limited thereto, and may also be accomplished by an electronic device 100. Examples of the learning algorithms may include supervised learning, unsupervised learning, semi-supervised learning, transfer learning, and reinforcement learning, and are not limited to these examples.

Each artificial intelligence model may be implemented, for example, as a convolutional neural network (CNN), a recurrent neural network (RNN), a restricted Boltzmann machine (RBM), a deep belief network (DBN), a bidirectional recurrent deep neural network (BRDNN), or a deep Q-network, and is not limited thereto.

A processor 120 for executing the artificial intelligence model according to an embodiment of the disclosure may be implemented through a combination of a processor and software, the processor including a general-purpose processor such as a central processor (CPU), an application processor (AP), or a digital signal processor (DSP), a graphics-only processor such as a graphic processing unit (GPU) or a vision processing unit (VPU), or an artificial intelligence-dedicated processor such as a neural processing unit (NPU). The processor 120 may perform control to process input data based on the predefined operation regulation or the artificial intelligence model, stored in memory 110. Alternatively, if the processor 120 is a dedicated processor (or the artificial intelligence-dedicated processor), the processor 120 may be designed to have a hardware structure specialized for processing a specific artificial intelligence model. For example, hardware specialized for processing the specific artificial intelligence model may be designed as a hardware chip such as an application specific integrated circuit (ASIC) or a field-programmable gate array (FPGA). If the processor 120 is implemented as the dedicated processor, the processor 120 may be implemented to include memory for implementing an embodiment of the disclosure, or may be implemented to include memory processing function for using external memory.

As another example, the memory 110 may store information on the artificial intelligence model including a plurality of layers. Storing the information on the artificial intelligence model may indicate storing various information related to an operation of the artificial intelligence model, for example, information on the plurality of layers included in the artificial intelligence model, information on a parameter used in each of the plurality of layers (for example, a filter coefficient or a bias).

Hereinafter, an embodiment of the disclosure is described in more detail with reference to the accompanying drawings.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

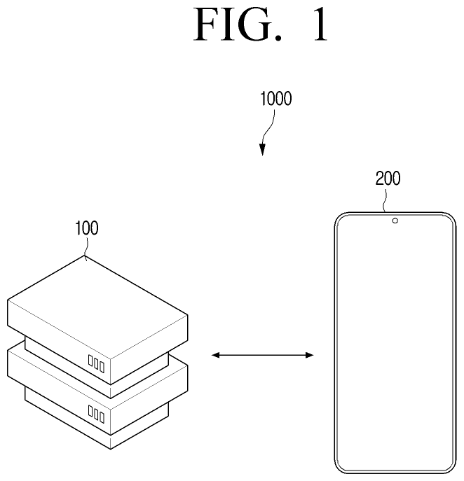

FIG. 1 is a diagram for describing a system including the electronic device and an external device according to an embodiment of the disclosure.

Referring to FIG. 1, a system 1000 may include an electronic device 100 and an external device 200.

The electronic device 100 may be a device that trains and compresses a specific learning model. The specific learning model may indicate an artificial intelligence model. The external device 200 may be a device that receives a compressed learning model obtained during a compression process. The external device 200 may provide a service to a user on the basis of the compressed (received) learning model.

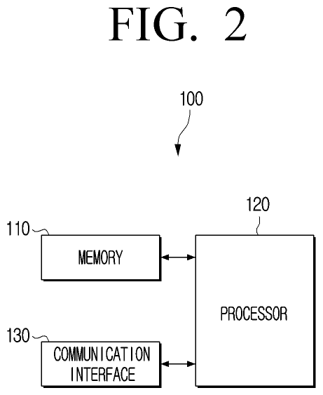

FIG. 2 is a block diagram showing a configuration included in the electronic device according to an embodiment of the disclosure.

Referring to FIG. 2, the electronic device 100 may include at least one of memory 110, at least one processor 120, or a communication interface 130.

The memory 110 may be implemented as an internal memory such as read-only memory (ROM, e.g., electrically erasable programmable read-only memory (EEPROM)) or random access memory (RAM), included in the processor 120, or as memory separate from the processor 120. In this case, the memory 110 may be implemented in the form of memory embedded in the electronic device 100 or in the form of memory detachable from the electronic device 100, on the basis of a data storage purpose. For example, data for driving the electronic device 100 may be stored in the memory embedded in the electronic device 100, and data for an extension function of the electronic device 100 may be stored in the memory detachable from the electronic device 100.

The memory embedded in the electronic device 100 may be implemented as at least one of volatile memory (e.g., dynamic RAM (DRAM), static RAM (SRAM) or synchronous dynamic RAM (SDRAM)) or non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash), hard drive, or solid state drive (SSD)); and the memory detachable from the electronic device 100 may be implemented as a memory card (e.g., compact flash (CF), secure digital (SD), micro secure digital (Micro-SD), mini secure digital (mini-SD), extreme digital (xD), or multi-media card (MMC)), external memory which may be connected to a universal serial bus (USB) port (e.g., USB memory), or the like.

The processor 120 may control overall operations of the electronic device 100. In detail, the processor 120 may function to control the overall operations of the electronic device 100.

The processor 120 may be implemented as a digital signal processor (DSP), a microprocessor, or a time controller (TCON), processing a digital signal. However, the processor 120 is not limited thereto, may include at least one of a central processing unit (CPU), a micro controller unit (MCU), a micro processing unit (MPU), a controller, an application processor (AP), a graphics-processing unit (GPU), a communication processor (CP) or an advanced reduced instruction set computer (RISC) machine (ARM) processor, or may be defined by these terms. In addition, the processor 120 may be implemented in a system-on-chip (SoC) or a large scale integration (LSI), in which a processing algorithm is embedded, or may be implemented in the form of the field programmable gate array (FPGA). In addition, the processor 120 may perform various functions by executing computer executable instructions stored in the memory.

The electronic device 100 may be a server that trains the artificial intelligence model.

The memory 110 may store a learning module including a first generator 141 that generates an input vector, a second generator 142 that generates synthetic data, and a first learning model 143 that analyzes the synthetic data.

At least one processor 120 may be connected to the memory 110 to control the electronic device 100.

At least one processor 120 may obtain (or acquire) the input vector from the first generator 141, obtain the synthetic data corresponding to the input vector by inputting the input vector into the second generator 142, obtain output data generated by analyzing the synthetic data through inputting the synthetic data into the first learning model 143, and learn at least one parameter included in the first generator 141 and at least one parameter included in the second generator 142 on the basis of the output data.

At least one processor 120 may obtain the input vector randomly generated by the first generator 141. The first generator 141 may generate the input vector having a Gaussian distribution through a random number that is randomly generated. The input vector may indicate a latent vector. In addition, the input vector may be a vector that uses a Gaussian distribution (N(0, I)). The input vector may be output data of the first generator 141.

At least one processor 120 may input (or provide) the input vector generated by the first generator 141 into (or to) the second generator 142. At least one processor 120 may obtain, from the second generator 142, the synthetic data corresponding to the input vector as output data of the second generator 142.

The synthetic data may indicate virtual data generated by the second generator 142 set on the basis of a user setting. The data that the user intends to generate may be described as target data. The second generator 142 may generate the synthetic data related to the target data on the basis of the input vector.

For example, it may be assumed that the target data is a dog. The second generator 142 may generate the synthetic data (or the virtual image) related to a dog on the basis of the input vector. The input vector may include a parameter required for generating a virtual image related to a dog. For example, the parameter of the input vector may include a parameter related to at least one of the eyes, nose, mouth, ears, species, or fur color of a dog. The first generator 141 may generate the input vector on the basis of the randomly generated random number related to the parameter related to a dog. At least one processor 120 may obtain the synthetic data (or the virtual image) related to a dog by providing the input vector obtained from the first generator 141 to the second generator 142.

At least one processor 120 may input (or provide) the synthetic data obtained from the second generator 142 into (or to) the first learning model 143. At least one processor 120 may obtain output data corresponding to the synthetic data from the first learning model 143.

The first learning model 143 may be a model that analyzes input data and outputs an analysis result as the output data.

According to various embodiments, the first learning model 143 may be a model that outputs statistical feature data corresponding to the input data as the output data. At least one processor 120 may learn at least one parameter included in the first generator 141 and at least one parameter included in the second generator 142 on the basis of the statistical feature data.

According to the various embodiments, the first learning model 143 may be a model that outputs a category probability value (or object probability value) corresponding to the input data as the output data. At least one processor 120 may learn at least one parameter included in the first generator 141 and at least one parameter included in the second generator 142 on the basis of the category probability value (or the object probability value).

According to the various embodiments, the first learning model 143 may be a discriminator model that determines whether the input data is real data or fake data in relation to the target data. At least one processor 120 may learn at least one parameter included in the first generator 141 and at least one parameter included in the second generator 142 on the basis of an output value of the discriminator.

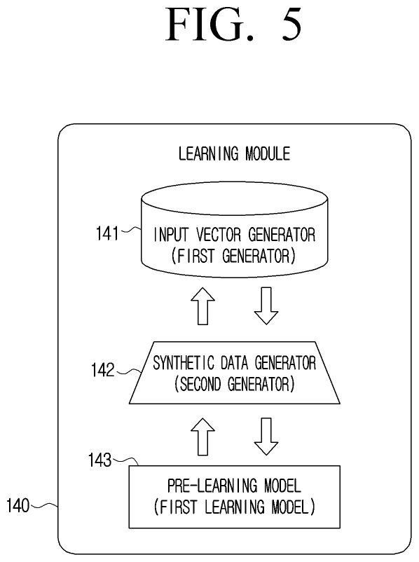

At least one processor 120 may learn at least one parameter included in the first generator 141 and at least one parameter included in the second generator 142 through a learning module 140. The learning module 140 may include the first generator 141, the second generator 142, and the first learning model 143. A detailed description of the learning module 140 is provided with reference to FIGS. 5, 6, 7, and the like.

Meanwhile, at least one processor 120 may obtain a loss value on the basis of the output data, and learn at least one parameter included in the first generator 141 and at least one parameter included in the second generator 142 to minimize the loss value.

At least one parameter included in the first generator 141 may include an element included in the latent vector. At least one parameter included in the second generator 142 may include a weight applied to the second generator 142.

Meanwhile, the output data may include the statistical feature data of the synthetic data. The statistical feature data may include at least one of a mean value, a standard deviation value, or a variance value.

Meanwhile, the output data may include the mean value and standard deviation value of the synthetic data, and at least one processor 120 may obtain a first difference value between the mean value of the synthetic data and a mean value of a batch normalization (BN) layer included in the first learning model 143, obtain a second difference value between the standard deviation value of the synthetic data and a standard deviation value of the batch normalization (BN) layer included in the first learning model 143, and obtain the loss value on the basis of the first difference value and the second difference value.

According to the various embodiments, at least one processor 120 may use the variance value instead of the standard deviation value.

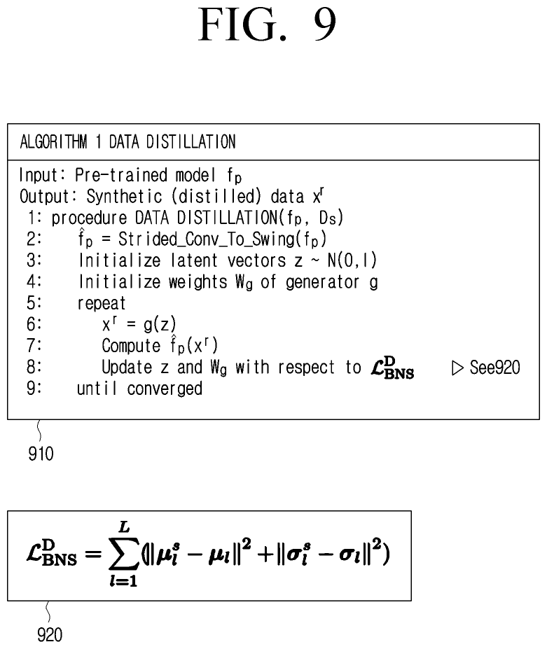

The first difference value may indicate “μl\hat{ }s−μl” in FIG. 9. The second difference value may indicate “σl\hat{ }s−σl” in FIG. 9. A specific operation for obtaining the loss value is described with reference to FIGS. 9, 13, 14, and the like.

Meanwhile, at least one processor 120 may obtain stride data of at least one convolutional layer included in the first learning model 143, and replace an identified convolutional layer with a swing convolution layer if the convolutional layer having a stride data size of 2 or more is identified among at least one convolutional layer, and the swing convolution layer may be a convolutional layer that randomly selects a computation object on the basis of padding data.

At least one processor 120 may identify the convolutional layer having the stride size of 2 or more among at least one convolutional layer included in the first learning model 143. In addition, at least one processor 120 may replace the identified convolutional layer with the swing convolution layer.

A model before the replacement operation is performed thereon may be described as the first learning model 143, and a model after the replacement operation is performed thereon may be described as a modified first learning model 144. The modified first learning model 144 may be described as a second learning model.

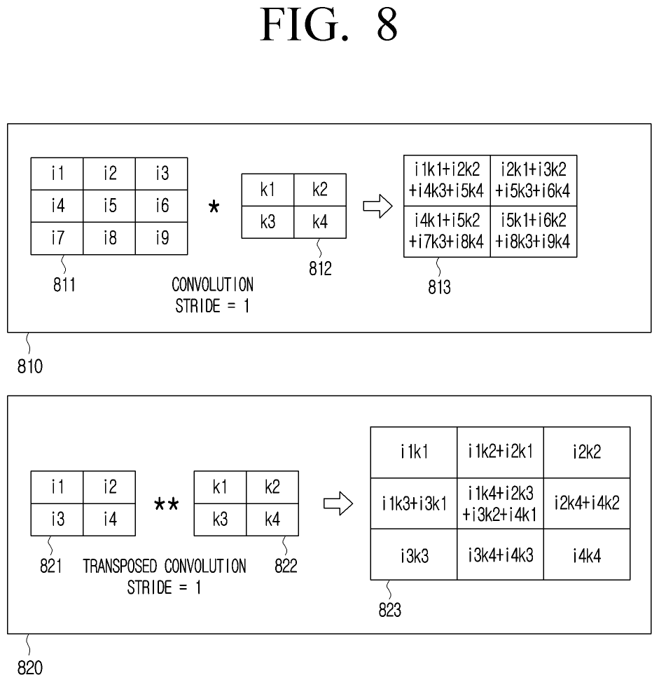

Stride may indicate a calculation unit (or step) in convolution computation. Descriptions of the convolution computation and transposed convolution computation are provided with reference to FIG. 8.

Meanwhile, the swing convolution layer may be a layer that includes an operation for obtaining second data 1120 by adding padding data 1121 to first data 1110 if the first data 1110 is input thereinto, an operation for obtaining third data 1130 by selecting some data regions from the second data 1120 on the basis of a size of the first data 1110, and an operation for performing the convolution computation on the basis of the third data 1130 and kernel data of the identified convolutional layer.

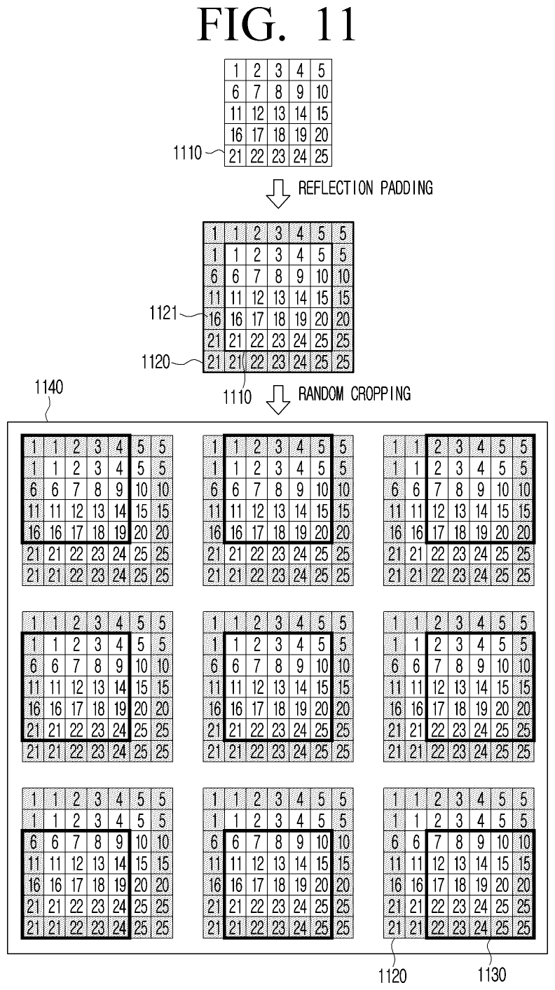

A specific description of the swing convolution layer is provided with reference to FIGS. 11, 12, 15, and the like.

Meanwhile, the first generator 141 may be a generator that generates the latent vector on the basis of at least one parameter, and at least one parameter included in the first generator 141 may be a parameter used to generate the synthetic data related to a target set by the user.

Meanwhile, the synthetic data may be image data related to the target set by the user.

Meanwhile, at least one processor 120 may obtain a second learning model 153 by quantizing the first learning model 143, and the second learning model 153 may be a compressed model of the first learning model 143.

A storage size of the second learning model 153 may be smaller than a storage size of the first generator 141. Therefore, the second learning model 153 may indicate a lighter model than the first learning model 143.

According to the various embodiments, the modified first learning model 144 may be described as the second learning model and the second learning model 153 may be described as the third learning model.

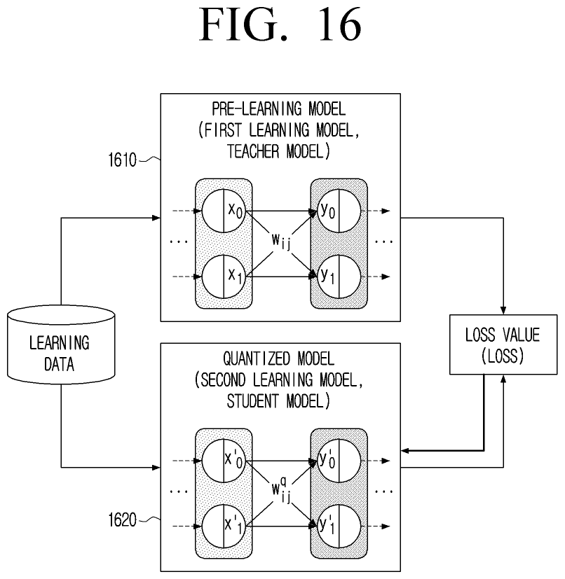

At least one processor 120 may perform a quantization operation by using the compression module 150. A specific description of the quantization operation is provided with reference to FIGS. 16 to 18.

Meanwhile, the electronic device 100 may further include the communication interface 130, and at least one processor 120 may transmit the second learning model 153 to the external device 200 through the communication interface 130.

The communication interface 130 may be a component that communicates with the various types of external devices by using various types of communication methods. The communication interface 130 may include a wireless communication module or a wired communication module. Each communication module may be implemented in the form of at least one hardware chip.

The wireless communication module may be a module that communicates with the external device in the wireless manner. For example, the wireless communication module may include at least one of a wireless-fidelity (Wi-Fi) module, a Bluetooth module, an infrared communication module, or another communication module.

The Wi-Fi module and the Bluetooth module may respectively perform the communication in the Wi-Fi manner and the Bluetooth manner. In case of using the Wi-Fi module or the Bluetooth module, the communication interface may first transmit and receive various connection information such as a service set identifier (SSID) or a session key, connect the communication by using this connection information, and then transmit and receive various information.

The infrared communication module may perform the communication based on infrared data association (IrDA) technology that transmits data in a short distance in the wireless manner by using an infrared ray between visible light and millimeter waves.

In addition to the above-described communication manners, another communication module may include at least one communication chip performing the communication on the basis of various wireless communication standards such as zigbee, third generation (3G), third generation partnership project (3GPP), long term evolution (LTE), LTE advanced (LTE-A), fourth generation (4G), and fifth generation (5G).

The wired communication module may be a module that communicates with the external device in the wired manner. For example, the wired communication module may include at least one of a local area network (LAN) module, an Ethernet module, a pair cable, a coaxial cable, an optical fiber cable, or an ultra wide-band (UWB) module.

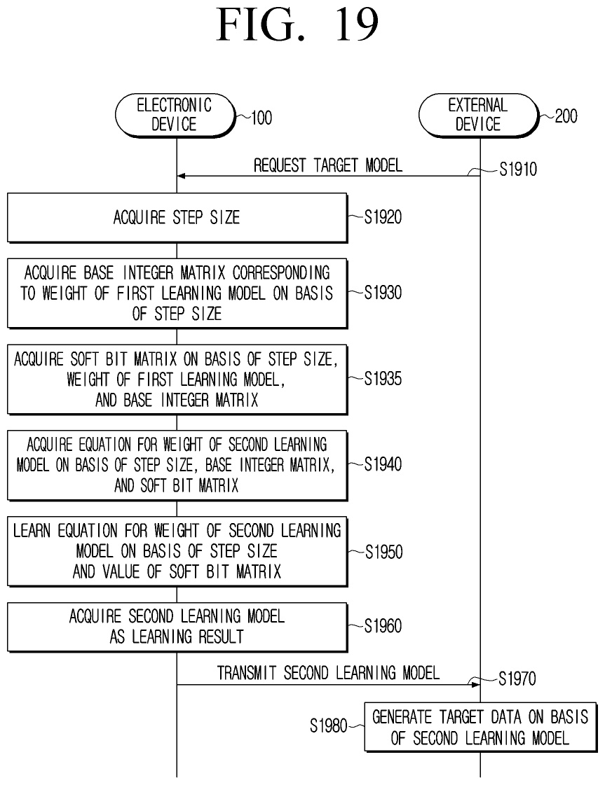

The external device 200 may request the compressed model from the electronic device 100. At least one processor 120 may transmit the compressed second learning model 153 in response to the request from the external device 200. A specific description of the transmission is provided with reference to FIG. 19.

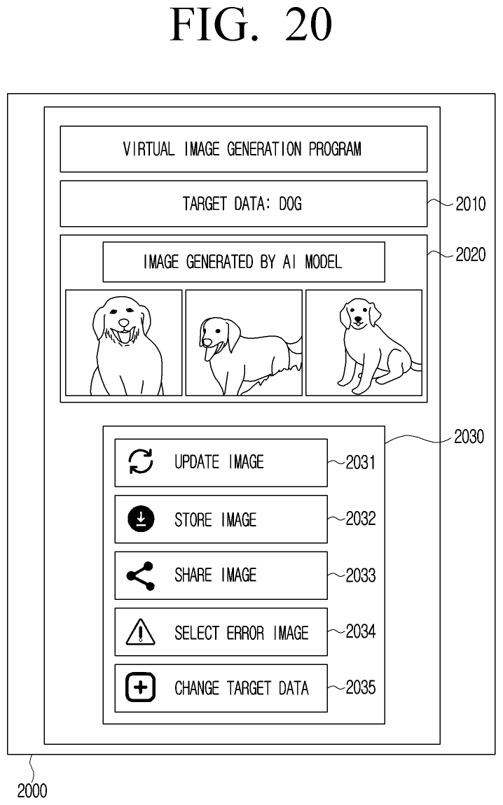

At least one processor 120 may provide a screen 2000 related to the synthetic data generation if the operation of learning at least one parameter included in the first generator 141 and at least one parameter included in the second generator 142 through the learning module 140 is completed. At least one processor 120 may display the screen 2000 by using a display (not shown) included in the electronic device 100 or a display (not shown) connected to the electronic device 100. A specific description of the configuration is provided with reference to FIG. 20.

The electronic device 100 according to the various embodiments may train (or update) the first generator 141 and the second generator 142 in generating the synthetic data. The electronic device 100 may improve quality of the synthetic data by updating both the input vector generation and the synthetic data generation.

The electronic device 100 according to the various embodiments may replace a specific convolution layer (the layer having the stride size of 2 or more) included in the first learning model 143 with the swing convolution layer. The swing convolution layer may prevent information loss caused by the stride by randomly selecting the computation target.

The electronic device 100 according to the various embodiments may quantize the first learning model 143 or the modified first learning model 144 by using the compression module 150. The quantized model may be used by a terminal device (for example, a mobile device) that has relatively low computational processing capability compared to a server or the like.

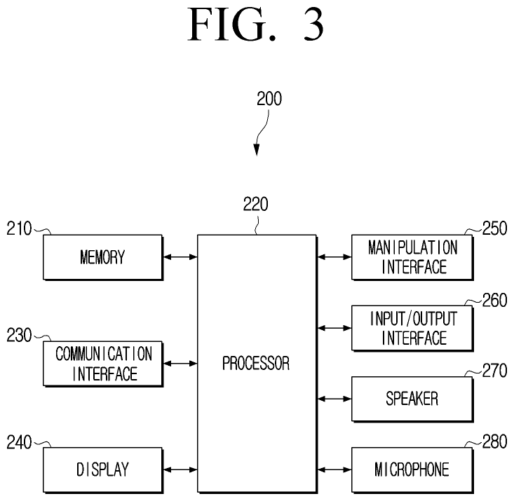

FIG. 3 is a block diagram showing a configuration included in an external device according to an embodiment of the disclosure.

Referring to FIG. 3, the external device 200 may include at least one of memory 210, at least one processor 220, a communication interface 230, a display 240, a manipulation interface 250, an input/output interface 260, a speaker 270, or a microphone 280.

The memory 210, at least one processor 220, and the communication interface 230 may respectively correspond to the memory 110, at least one processor 120, and the communication interface 130 in FIG. 2. The description omits their redundant descriptions.

The display 240 may be implemented as various types of displays such as a liquid crystal display (LCD), an organic light emitting diode (OLED) display, a plasma display panel (PDP). The display 240 may also include a driving circuit, a backlight unit, and the like, which may be implemented in a form such as an amorphous silicon thin film transistor (a-si TFT), a low temperature poly silicon (LTPS) TFT, or an organic TFT (OTFT). The display 240 may be implemented as a touch screen coupled with a touch sensor, a flexible display, a three-dimensional (3D) display, or the like. In addition, the display 240 according to an embodiment of the disclosure may include not only a display panel outputting an image, but also a bezel housing the display panel. In particular, the bezel may include the touch sensor (not shown) detecting user interaction according to an embodiment of the disclosure.

The manipulation interface 250 may be implemented as a device such as a button, a touch pad, a mouse, or a keyboard, or may be implemented as a touch screen capable of also performing a manipulation input function in addition to the above-described display function. The button may be any of various types of buttons such as a mechanical button, a touch pad, or a wheel, which is disposed in any region, such as the front surface portion, side surface portion, or rear surface portion of a body appearance of the external device 200.

The input/output interface 260 may be any of a high definition multimedia interface (HDMI), a mobile high-definition link (MHL), a universal serial bus (USB), a display port (DP), a thunderbolt, a video graphics array (VGA) port, a red-green-blue (RGB) port, a D-subminiature (D-SUB), or a digital visual interface (DVI). The input/output interface 260 may input/output at least one of an audio signal or a video signal. According to an implementation example, the input/output interface 260 may include a port for inputting and outputting only the audio signal and a port for inputting and outputting only the video signal as its separate ports, or may be implemented as a single port for inputting and outputting both the audio signal and the video signal. The external device 200 may transmit at least one of the audio signal or the video signal to an external device (e.g., external display device or external speaker) through the input/output interface 260. In detail, the output port included in the input/output interface 260 may be connected to the external device, and the external device 200 may transmit at least one of the audio signal or the video signal to the external device 200 through the output port.

The speaker 270 may be a component for outputting not only various audio data but also various notification sounds, voice messages, or the like.

The microphone 280 may be a component for receiving a user voice or another sound and converting the same to the audio data. The microphone 280 may receive the user voice while activated. For example, the microphone 280 may be integrated with the external device 200 in its upper, front, or side direction. The microphone 280 may include various components such as a microphone collecting the user voice in an analog form, an amplifier circuit amplifying the collected user voice, an analog to digital (A/D) conversion circuit sampling the amplified user voice and converting the same into the digital signal, and a filter circuit removing a noise component from the converted digital signal.

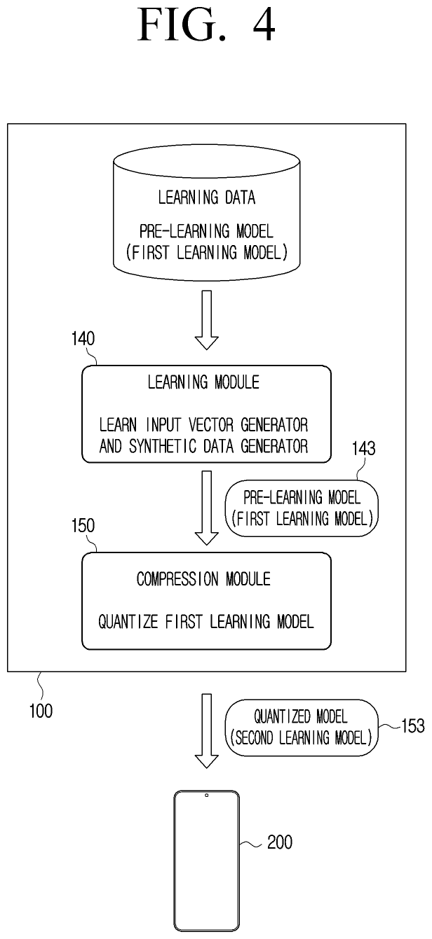

FIG. 4 is a diagram for describing a learning module and a compression module according to an embodiment of the disclosure.

Referring to FIG. 4, the electronic device 100 may include the learning module 140 and the compression module 150. The electronic device 100 may store the learning module 140 and the compression module 150 in the memory 110. The electronic device 100 may store learning data in the memory 110. The learning module 140 may be described as a learning system, a learning network, or the learning model.

The learning data may include the first learning model 143. The first learning model 143 may be a model that analyzes the input data and outputs the analysis result as the output data.

According to the various embodiments, the first learning model 143 may be a model that outputs the statistical feature data corresponding to the input data as the output data.

According to the various embodiments, the first learning model 143 may be a model that outputs the category probability value (or the object probability value) corresponding to the input data as the output data.

According to the various embodiments, the first learning model 143 may be the discriminator model that determines whether the input data is the real data or the fake data in relation to the target data.

The learning module 140 may be a model that learns the input vector generator (the first generator 141) and the synthetic data generator (the second generator 142). The learning module 140 may be a model that updates the first generator 141 and the second generator 142 by comparing the synthetic data with predetermined data. The synthetic data may be described as distilled data. An update operation may include an operation for learning at least one parameter included in each generator. After completing the update operation (or the learning operation), the learning module 140 may transmit the first learning model 143 to the compression module 150.

The compression module 150 may be a model that quantizes the first learning model 143 received from the learning module 140. The compression module 150 may obtain the second learning model 153 by compressing the first learning model 143 based on a quantization result. The storage size of the second learning model 153 may be smaller than the storage size of the first learning model 143. Therefore, the second learning model 153 may be implemented even on the terminal device (for example, the external device 200) that has relatively low memory processing capability.

The compression module 150 may transmit the second learning model 153 to the external device 200. The external device 200 may provide the user with a service related to the artificial intelligence on the basis of the second learning model 153 received from the compression module 150 of the electronic device 100.

FIG. 5 is a diagram for describing an operation performed by a learning module according to an embodiment of the disclosure.

Referring to FIG. 5, the learning module 140 may include the first generator 141, the second generator 142, and the first learning model 143.

The first generator 141 may be the input vector generator. The first generator 141 may perform the operation of generating the input vector, and the generated input vector may be a vector generated on the basis of the random number. In addition, the input vector may indicate the latent vector. In addition, the input vector may be the vector that uses the Gaussian distribution (N(0, I)). The first generator 141 may transmit the generated input vector to the second generator 142.

The second generator 142 may be the synthetic data generator. The second generator 142 may receive the generated input vector from the first generator 141. The second generator 142 may generate the synthetic data on the basis of the input vector. The synthetic data may be the data related to the target set by the user. The user may input a setup command (or control command) for generating the target. The learning module 140 may randomly generate the synthetic data related to the target on the basis of the user input. The learning module 140 may generate the synthetic data related to the target on the basis of the randomly generated input vector. The second generator 142 may transmit the synthetic data to the first learning model 143.

The first learning model 143 may receive the synthetic data from the second generator 142. The first learning model 143 may use the synthetic data as the input data. The first learning model 143 may obtain the output data corresponding to the synthetic data.

The output data may be the statistical feature data. The statistical feature data may include the mean value and the standard deviation value. The first learning model 143 may obtain the mean value and the standard deviation value corresponding to the synthetic data as the output data.

The learning module 140 may perform the learning operation on the basis of the first generator 141, the second generator 142, and the first learning model 143. The learning module 140 may learn at least one of the first generator 141, the second generator 142, or the first learning model 143 on the basis of the output data corresponding to the synthetic data.

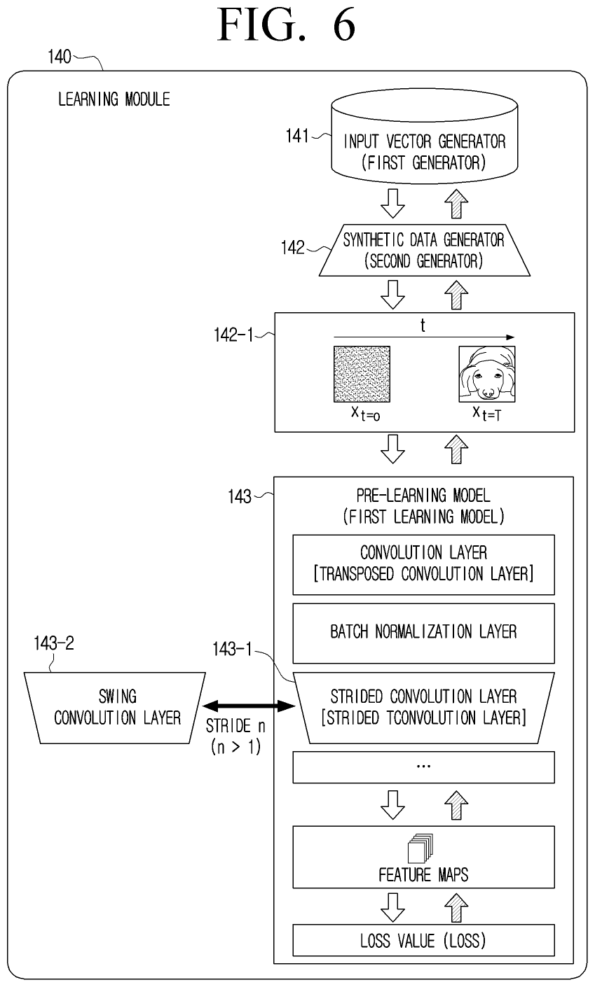

FIG. 6 is a diagram for specifically describing the operation performed by the learning module 140 according to an embodiment of the disclosure.

Referring to FIG. 6, descriptions of the first generator 141, the second generator 142, and the first learning model 143 with reference to FIG. 6 are already described with reference to FIG. 5, and their redundant descriptions are thus omitted.

The learning module 140 may obtain synthetic data 142-1 from the second generator 142. The synthetic data 142-1 may be continuously modified as the learning operation is repeated.

For example, it may be assumed that the target is a dog and the second generator 142 generates a dog image. The synthetic data 142-1 may be noise data in an initial learning operation at time point t=0. However, the synthetic data 142-1 may clearly include an object representing a dog in the learning operation at time point t=T.

The first learning model 143 may include at least one of the convolutional layer (or transposed convolutional layer) or the batch normalization (BN) layer. In addition, the first learning model 143 may include the convolutional layer having the stride size of 2 or more. The convolutional layer having the stride size of 2 or more may be described as a “strided convolution layer”. The stride may indicate the calculation unit (or step) used to perform the convolution computation.

The learning module 140 may modify (or transform) a convolutional layer 143-1 having the stride size of 2 or more among at least one layer included in the first learning model 143. The learning module 140 may modify the convolutional layer 143-1 having the stride size of 2 or more into a swing convolution layer 143-2.

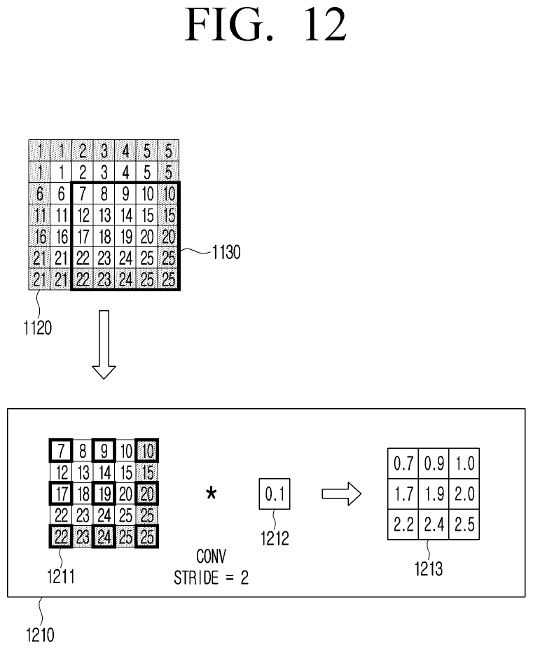

The swing convolution layer 143-2 may be a modified computation layer of a conventional convolution computation method. A specific description of the swing convolution layer is provided with reference to FIGS. 11 and 12.

The learning module 140 may perform a computation operation on the synthetic data to thus obtain a feature map, and may obtain the loss value (i.e., first loss value) on the basis of the feature map. In addition, the learning module 140 may perform the learning operation to minimize the loss value.

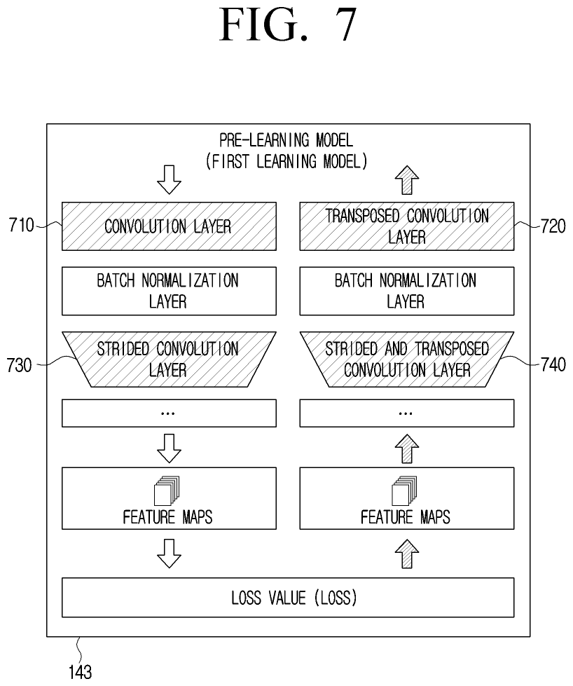

FIG. 7 is a diagram for describing forward propagation and back propagation processes performed by a learning module according to an embodiment of the disclosure.

Referring to FIG. 7, the learning module 140 may perform the learning operation by using the forward propagation and back propagation processes.

It may be assumed that the first learning model 143 uses a convolutional layer 710 in the forward propagation process. The first learning model 143 may use a transposed convolutional layer 720 instead of the convolutional layer 710 in the back propagation process.

It may be assumed that the first learning model 143 uses a convolutional layer 730 having the stride size of 2 or more in the forward propagation process. The first learning model 143 may use a transposed convolutional layer 740 instead of the convolutional layer 730 in the back propagation process.

FIG. 8 is a diagram for describing a convolution computation and a transposed convolution computation according to an embodiment of the disclosure.

Referring to FIG. 8, embodiment 810 in FIG. 8 shows a computation process performed by the convolutional layer. In Embodiment 810, the stride size may be assumed to be 1. The electronic device 100 may obtain output data 813 by performing the convolution computation on input data 811 and kernel data 812. A size of the input data may be reduced by the convolution computation. Therefore, the convolution computation may indicate down sampling.

Embodiment 820 in FIG. 8 shows a computation process performed by the transposed convolutional layer. In Embodiment 820, the stride size may be assumed to be 1. The electronic device 100 may obtain output data 823 by performing the convolution computation on input data 821 and kernel data 822. A size of the input data may be increased by the transposed convolution computation. Therefore, the convolution computation may indicate up sampling.

FIG. 9 is a diagram for describing a learning operation performed by a learning module according to an embodiment of the disclosure.

Referring to FIG. 9, algorithm 910 shows the learning operation performed by the learning module 140. The learning module 140 may receive a pre-learning model fp as the input data. The pre-learning model fp may indicate the first learning model 143.

The learning module 140 may obtain synthetic data x\hat{ }r as the output data.

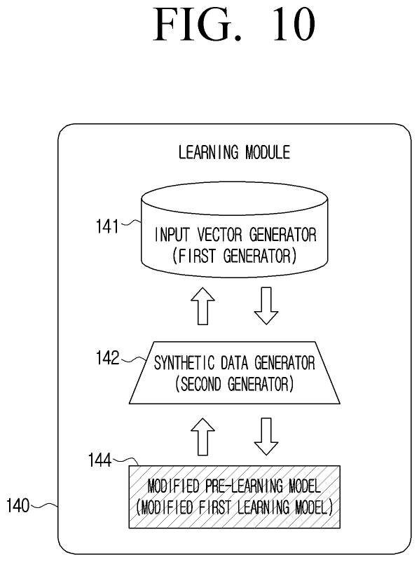

The learning module 140 may modify the specific convolution layer (the layer having the stride size of 2 or more) included in the pre-learning model fp into the swing convolution layer. A model that includes the modified layer may be described as a modified pre-learning model fp\hat{ }. The modified pre-learning model fp\hat{ } may indicate the modified first learning model 144 in FIG. 10. The learning module 140 may obtain the modified pre-learning model fp\hat{ } through the layer modification operation.

The learning module 140 may initialize a latent vector z. The latent vector z may indicate the input vector generated by the first generator 141. The latent vector z may follow the Gaussian distribution (N(0, I)).

The learning module 140 may initialize a weight Wg included in a generator G. The generator G may indicate the second generator 142.

The learning module 140 may obtain synthetic data x\hat{ }r by inputting the latent vector z into the generator G.

The learning module 140 may input the synthetic data x\hat{ }r into the modified pre-learning model fp\hat{ }.

The learning module 140 may update (or learn) the latent vector z and the weight Wg included in the generator G based on a loss value L_BNS. BNS may indicate the batch normalization layers.

The learning module 140 may repeat the update operation until a specific condition is satisfied. The learning module 140 may input the latent vector z into the generator G until the specific condition is satisfied to thus repeat an operation of obtaining the synthetic data x\hat{ }r, an operation of inputting the synthetic data x\hat{ }r into the modified pre-learning model fp\hat{ }, an operation of updating the latent vector z and the weight Wg included in the generator G on the basis of the loss value L_BNS.

Equation 920 in FIG. 9 shows a process of calculating the loss value L_BNS.

Here, 1 indicates the number to specify the BN layer. L indicates the total number of BN layers included in the first learning model 143.

μl\hat{ }s indicates the mean value corresponding to the synthetic data.

μl indicates the mean value of a specific BN layer included in the first learning model 143.

σl\hat{ }s indicates the standard deviation value corresponding to the synthetic data.

σl indicates the standard deviation value of the specific BN layer included in the first learning model 143.

“∥ ∥” indicates a norm computation symbol.

The learning module 140 may obtain the loss value L_BNS on the basis of Equation 920. The learning module 140 may update (or learn) the latent vector z and the weight Wg included in the generator G to minimize the loss value L_BNS.

FIG. 10 is a diagram for describing an operation for modifying a first learning model according to an embodiment of the disclosure.

Referring to FIG. 10, the first generator 141 and the second generator 142 are already described with reference to FIG. 5, and their redundant descriptions are thus omitted.

The learning module 140 may modify the specific convolution layer included in the first learning model 143. The learning module 140 may modify the convolutional layer having the stride size of 2 or more into the swing convolution layer. A description of the swing convolution layer may be provided with reference to FIGS. 11 and 12. If the swing convolution layer is modified from the first learning model 143, the electronic device 100 may obtain the modified first learning model 144.

The modified first learning model 144 may be described as the second learning model. If the second learning model is described as such, the quantized learning model (i.e., second learning model 153) in FIG. 4 may be described a third learning model.

FIG. 11 is a diagram for describing an operation of selecting a computation target by using a swing convolution layer according to an embodiment of the disclosure.

Referring to FIG. 11, the learning module 140 may perform the convolution computation by using the swing convolution layer. The learning module 140 may add the padding data 1121 to the first data 1110. An operation of adding the padding data 1121 may be referred to as “reflection padding”. The first data 1110 may be the input data input into the swing convolution layer.

The padding data 1121 may be data in which an outer region of the first data 1110 is expanded to modify the size of the first data 1110 to be larger. The learning module 140 may obtain the second data 1120 coupled with the first data 1110 and the padding data 1121.

The learning module 140 may obtain the third data 1130 by selecting a specific region from the second data 1120 based on the size of the first data 1110. The specific region may be selected based on a random criterion.

A plurality of candidate data may exist if the specific region is selected based on the size of the first data 1110 from the second data 1120. One data may be randomly selected from selectable candidate data 1140. Randomly selected data may be described as the third data 1130. The operation of selecting the specific region from the second data 1120 may be described as “random cropping”.

FIG. 12 is a diagram for describing an operation of performing a computation on a computation target by using a swing convolution layer according to an embodiment of the disclosure.

Referring to FIG. 12, the learning module 140 may perform the convolution computation by using the swing convolution layer. In an embodiment in FIG. 11, it may be assumed that third data 1131 is randomly selected from the second data 1120.

Referring to Embodiment 1210, the learning module 140 may perform the convolution computation on input data 1211. The input data 1211 may indicate the third data 1130. The learning module 140 may obtain output data 1213 by performing the convolution computation on the basis of the input data 1211 and kernel data 1212.

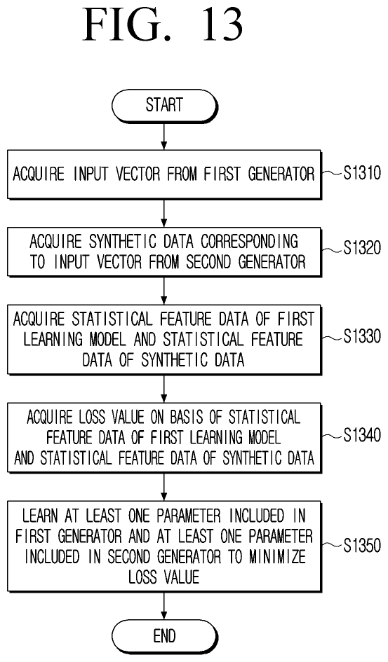

FIG. 13 is a flowchart for describing a learning operation of a learning module according to an embodiment of the disclosure.

Referring to FIG. 13, the electronic device 100 may obtain the input vector from the first generator 141 at operation S1310.

The electronic device 100 may obtain the synthetic data corresponding to the input vector from the second generator 142 at operation S1320.

The electronic device 100 may obtain the statistical feature data of the first learning model 143 and the statistical feature data of the synthetic data at operation S1330. The statistical feature data may be the data obtained from the first learning model 143. The statistical feature data of the first learning model 143 may include the statistical feature data related to the batch normalization (BN) layer included in the first learning model. The statistical feature data of the synthetic data may indicate the data obtained as the output data by inputting the synthetic data into the first learning model 143.

The electronic device 100 may obtain the loss value on the basis of the statistical feature data of the first learning model 143 and the statistical feature data of the synthetic data at operation S1340. The operation of obtaining the loss value may use Equation 920 in FIG. 9.

The electronic device 100 may learn (or update) at least one parameter included in the first generator 141 and at least one parameter included in the second generator 142 to minimize the loss value at operation S1350. At least one parameter included in the first generator 141 may include the parameter included in the input vector (or the latent vector). At least one parameter included in the second generator 142 may include at least one weight applied to the second generator 142.

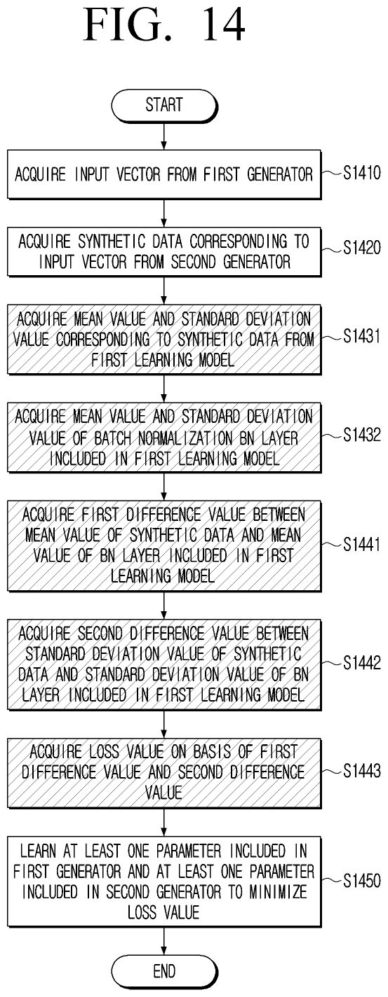

FIG. 14 is a flowchart for specifically describing a learning operation of a learning module according to an embodiment of the disclosure.

Referring to FIG. 14, operations S1410, S1420, and S1450 in FIG. 14 may correspond to operations S1310, S1320, and S1350 in FIG. 13. Their redundant descriptions are thus omitted.

The electronic device 100 may obtain the mean value and the standard deviation value corresponding to the synthetic data from the first learning model 143 after the synthetic data is obtained from the second generator 142 at operation S1431.

The electronic device 100 may obtain the mean value and standard deviation value of the BN layer included in the first learning model 143 at operation S1432.

The electronic device 100 may obtain the first difference value between the mean value of the synthetic data and the mean value of the BN layer included in the first learning model 143 at operation S1441. The first difference value may indicate “μl\hat{ }s−μl” in FIG. 9.

The electronic device 100 may obtain the second difference value between the standard deviation value of the synthetic data and the standard deviation value of the BN layer included in the first learning model 143 at operation S1442. The second difference value may indicate “σl\hat{ }s−σl” in FIG. 9.

The electronic device 100 may obtain the loss value on the basis of the first difference value and the second difference value at operation S1443. The loss value may indicate “L_BNS” in FIG. 9.

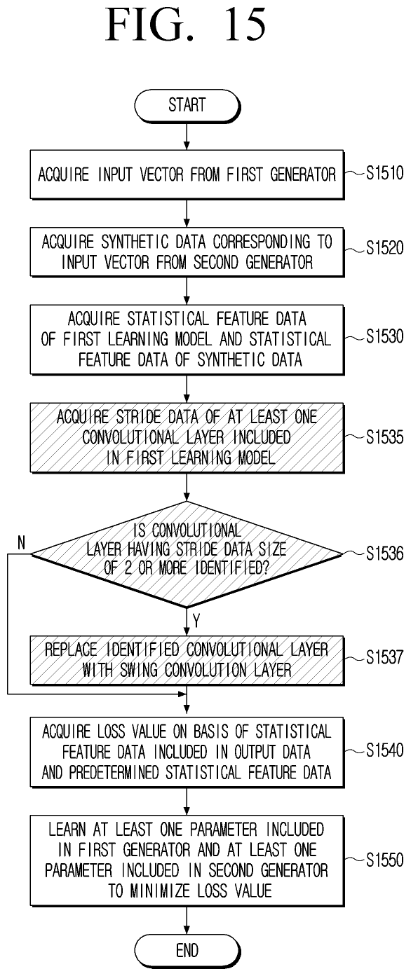

FIG. 15 is a flowchart for describing an operation of replacing a specific convolution layer with a swing convolution layer according to an embodiment of the disclosure.

Referring to FIG. 15, operations S1510, S1520, S1530, S1540, and S1550 in FIG. 15 may correspond to operations S1310, S1320, S1330, S1340, and S1350 in FIG. 13. Their redundant descriptions are thus omitted.

The electronic device 100 may obtain the stride data of at least one convolutional layer included in the first learning model 143 after obtaining the statistical feature data at operation S1535.

The electronic device 100 may determine whether the convolutional layer having the stride data size of 2 or more is identified at operation S1536.

The electronic device 100 may replace (or modify) the identified convolutional layer with the swing convolution layer at operation S1537 if the convolutional layer having the stride data size of 2 or more is identified at operation S1536-Y. The description of the swing convolution layer may be provided with reference to FIGS. 11 and 12. The electronic device 100 may then perform operations S1540 and S1550.

The electronic device 100 may perform operations S1540 and S1550 if the convolutional layer having the stride data size of 2 or more is not identified at operation S1536-N.

FIG. 15 shows that operations S1535 to S1537 are performed after operation S1530. However, operations S1535 to S1537 may be performed before operation S1530 according to the various embodiments.

FIG. 16 is a diagram for describing a quantization process according to an embodiment of the disclosure.

Referring to FIG. 16, the electronic device 100 may perform the quantization on a pre-learning model 1610 by using the compression module 150. The pre-learning model 1610 may be the first learning model 143 in FIG. 4, the first learning model 143 in FIG. 5, or the modified first learning model 144 in FIG. 10. The compression module 150 may use the pre-learning model 1610 as a teacher model.

The compression module 150 may quantize the pre-learning model 1610 to thus obtain a quantized model (i.e., second learning model 1620). The quantized model (i.e., second learning model 1620) may be the second learning model 153 in FIG. 4. The compression module 150 may use the second learning model 153 as a student model.

The compression module 150 may supply the learning data to both the pre-learning model 1610 and the quantized model (i.e., second learning model 1620). In addition, the compression module 150 may obtain the loss value (i.e., second loss value) on the basis of the output data that is output from the pre-learning model 1610 and the output data that is output from the quantized model (i.e., second learning model 1620). In addition, the compression module 150 may learn the quantized model (i.e., second learning model 1620) on the basis of the loss value.

For convenience of distinction, the loss value obtained by the learning module 140 may be described as the first loss value, and the loss value obtained by the compression module 150 may be described as the second loss value.

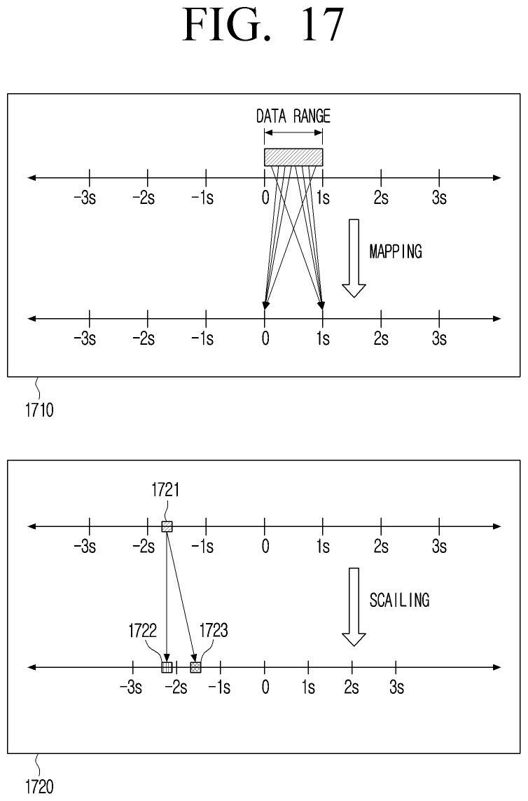

FIG. 17 is a diagram for describing a compression operation in a quantization process according to an embodiment of the disclosure.

Referring to FIG. 17, the quantization operation may include at least one of a mapping operation or a scaling operation. The quantization operation may be described as a categorization operation.

Embodiment 1710 in FIG. 17 shows an operation for mapping the data. The data may indicate the information (or the weight) included in the first learning model 143.

For example, it may be assumed that the plurality of data exist between 0 and 1a. The compression module 150 may quantize the data on the basis of a step size. The step size may indicate a data unit required for the quantization. The step size may be described as a scaling factor.

In Embodiment 1710, the step size may be assumed to be a. The compression module 150 may classify the data existing between 0 and 1a as “0” or “1a”. At least one of a nearest-rounding function, a ceiling function, or a floor function may be used in the classification operation. The classification operation may be described as the mapping operation.

Embodiment 1720 in FIG. 17 shows an operation for scaling the data. The data may be scaled to the user setting or a predetermined size. In the scaling operation, it may be necessary to modify data 1721 before the scaling is performed thereon to a relative position 1723 rather than an absolute position 1722. For this purpose, a specific algorithm may be applied to the compression module 150.

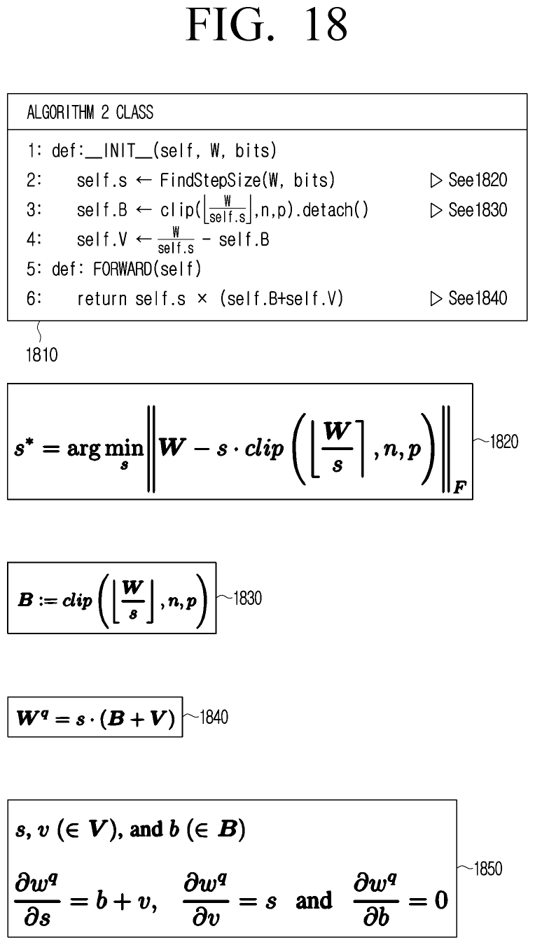

FIG. 18 is a diagram for describing a learning operation performed by a compression module according to an embodiment of the disclosure.

Referring to FIG. 18, algorithm 1810 in FIG. 18 shows the learning operation performed by the compression module 150. The compression module 150 may obtain a step size self.s by using Equation 1820.

The compression module 150 may obtain a base integer matrix self.B by using Equation 1830.

The compression module 150 may obtain a softbit matrix self. V on the basis of the step size self.s and the base integer matrix self.B. The compression module 150 may obtain the softbit matrix self. V by subtracting the base integer matrix self.B from a weight W of the first learning model 1610.

The compression module 150 may obtain a weight Wq of the second learning model 1620 on the basis of the step size self.s, the softbit matrix self.V, and the base integer matrix self.B. The compression module 150 may obtain the weight Wq by using Equation 1840.

Equation 1820 may be an equation for calculating a step size s*.

s* indicates the step size.

argmin_s(fx) indicates a function that finds an s value that minimizes fx.

s indicates an unknown number representing the step size.

W indicates the weight of the first learning model 1610.

Function clip(gx) indicates a function that converts a real number corresponding to gx into an integer. Function clip(gx) in Equation 1820 may use a nearest-rounding function.

n indicates a lower bound of the conversion in function clip(gx).

p indicates an upper bound of the conversion in function clip(gx).

“∥ ∥F” indicates Frobenius norm.

Equation 1830 may be an equation for calculating a base integer matrix B.

Function clip(gx) indicates the function that converts the real number corresponding to gx into the integer. Function clip(gx) in Equation 1830 may use a floor function.

W indicates the weight of the first learning model 1610.

s indicates the step size s* in Equation 1820.

n indicates the lower bound of the conversion in function clip(gx).

p indicates the upper bound of the conversion in function clip(gx).

Equation 1840 may be an equation for calculating the weight Wq of the second learning model 1620.

Wq indicates the weight of the second learning model 1620.

s indicates the step size s* in Equation 1820.

B indicates the base integer matrix B in Equation 1830.

V indicates a softbit matrix V having values between 0 and 1.

For example, it may be assumed that a weight of 1.4 is converted into 1. Here, 0.4 corresponding to a decimal point may correspond to V.

Equation 1850 may be an equation for differentiating the weight Wq of the second learning model 1620. The compression module 150 may differentiate the weight Wq of the second learning model 1620 by the step size s or the weight Wq of the second learning model 1620 by a value v of the soft bit. The compression module 150 may perform the learning operation on the basis of the step size s and the value v of the soft bit. The compression module 150 may not perform the learning operation on a value B of the base integer matrix. The reason is that the value B of the base integer matrix may indicate a constant.

FIG. 19 is a flowchart for describing an operation of transmitting a second learning model to an external device according to an embodiment of the disclosure.

Referring to FIG. 19, the external device 200 may request a target model from the electronic device 100 at operation S1910. The electronic device 100 may obtain the second learning model 153 in response to the request received from the external device 200.

The electronic device 100 may obtain the weight W of the first learning model 143.

The electronic device 100 may obtain the step size s of the first learning model 143 at operation S1920. The electronic device 100 may obtain the step size s by using Equation 1820 in FIG. 18. The first learning model 143 may be replaced with the modified first learning model 144.

The electronic device 100 may obtain the base integer matrix B corresponding to the weight W of the first learning model 143 on the basis of the step size s at operation S1930. The electronic device 100 may obtain the base integer matrix B by using Equation 1830 in FIG. 18.

The electronic device 100 may obtain the soft bit matrix V on the basis of the step size s, the weight W of the first learning model, and the base integer matrix B at operation S1935.

The electronic device 100 may obtain Equation 1840 (in FIG. 18) for the weight of the second learning model 153 on the basis of the step size s, the base integer matrix B, and the soft bit matrix V at operation S1940.

The electronic device 100 may learn Equation 1840 (in FIG. 18) for the weight of the second learning model 153 on the basis of the step size s and the value v of the soft bit matrix at operation S1950. The learning operation may be performed using Equation 1850 in FIG. 18.

The electronic device 100 may obtain the second learning model 153 as a learning result at operation S1960. The electronic device 100 may transmit the second learning model 153 to the external device 200 at operation S1970. The external device 200 may generate the target data on the basis of the second learning model 153 received from the electronic device 100 at operation S1980. The target data is the output data of the second learning model 153 and may indicate service information provided to the user.

FIG. 20 is a diagram for describing a screen related to a virtual image generation program according to an embodiment of the disclosure.

Referring to FIG. 20, it may be assumed that the synthetic data generated from the electronic device 100 is virtual image data. The electronic device 100 may provide the screen 2000 related to the virtual image generation through the display (not shown).

The screen 2000 may include at least one of a user interface (UI) 2010 that displays the target data, a UI 2020 that displays the generated virtual image data, or a UI 2030 that guides user selection.

The UI 2010 may indicate the target information (or the target data) set by the user. In an embodiment in FIG. 20, it may be assumed that the user determines to generate a dog.

The UI 2020 may include the synthetic data (the virtual image) generated by the second generator 142.

The UI 2030 may include at least one detailed UI 2031, 2032, 2033, 2034, or 2035 for processing the generated synthetic data (virtual image) in response to the user input.

The UI 2031 may include at least one of an icon or text for updating the virtual image.

The UI 2032 may include at least one of an icon or text for storing the virtual image.

The UI 2033 may include at least one of an icon or text for sharing the virtual image.

The UI 2034 may include at least one of an icon or text for selecting an error image.

The UI 2035 may include at least one of an icon or text for changing the target data.

According to the various embodiments, the electronic device 100 may display the screen 2000 related to the synthetic data generation after the learning operation is completed by the learning module 140. The reason is to enable checking performance of the learning module 140 after learning is completed. If the error image is selected, the learning operation of the learning module 140 may be performed again. If the error image is selected through the UI 2034, the electronic device 100 may retrain (or re-update) the learning module 140.

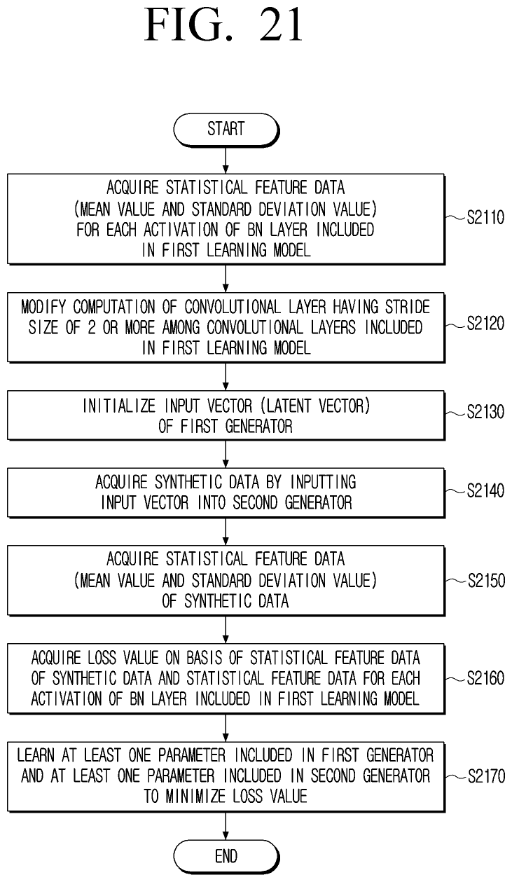

FIG. 21 is a flow chart for describing a learning operation of a learning module according to an embodiment of the disclosure.

Referring to FIG. 21, the electronic device 100 may obtain the statistical feature data (the mean value and the standard deviation value) for each activation of the batch normalization (BN) layer included in the first learning model 143 at operation S2110.

The electronic device 100 may modify the computation of the convolutional layer having the stride size of 2 or more among the convolutional layers included in the first learning model 143 at operation S2120. The quality of the synthetic data may be improved through a computation modified operation.

The electronic device 100 may initialize the input vector (the latent vector) of the first generator 141 at operation S2130.

The electronic device 100 may obtain the synthetic data by inputting the input vector into the second generator 142 at operation S2140.

The electronic device 100 may obtain the statistical feature data (the mean value and the standard deviation value) of the synthetic data at operation S2150.

The electronic device 100 may obtain the loss value on the basis of the statistical feature data of the synthetic data and the statistical feature data for each activation of the batch normalization (BN) layer included in the first learning model 143 at operation S2160.

The electronic device 100 may learn at least one parameter included in the first generator 141 and at least one parameter included in the second generator 142 to minimize the loss value at operation S2170.

In the learning operation by the learning module 140, the description describes one first learning model 143. According to the various embodiments, the plurality of first learning models 143 may be provided.

The operation shown in FIG. 21 may be performed using the variance value instead of the standard deviation value.

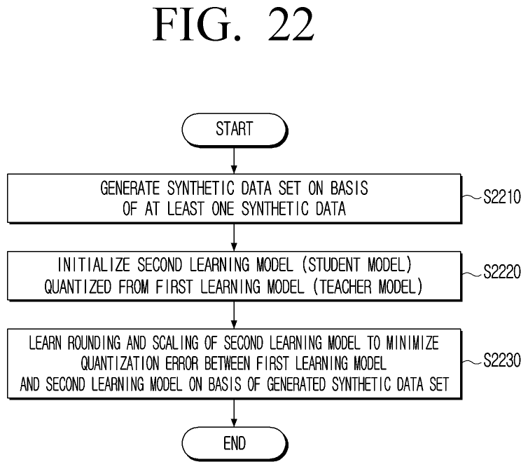

FIG. 22 is a flow chart for describing a learning operation of a compression module according to an embodiment of the disclosure.

Referring to FIG. 22, the electronic device 100 may generate synthetic data set on the basis of at least one synthetic data at operation S2210. At least one synthetic data may be the data generated by the second generator 142.

The electronic device 100 may initialize the second learning model (the student model) 153 quantized from the first learning model (the teacher model) 143 at operation S2220.

The electronic device 100 may learn the rounding and scaling of the second learning model 153 to minimize a quantization error between the first learning model 143 and the second learning model 153 on the basis of the generated synthetic data set at operation S2230.

The quantization learning operation of the second learning model 153 may be optimized at a layer level, a block level, a network level, or a unit for combining the outputs of the plurality of layers.

The operation of generating the virtual data and the operation of quantizing the model may be performed simultaneously. The second generator 142 may be trained to generate the synthetic data by considering the quantization error.

The electronic device 100 may perform joint optimization by relaxing the mutual dependency between a bit-code and the scaling factor. The quantization learning operation of the second learning model 153 may be performed on the real data instead of the synthetic data (the virtual data).

The electronic device 100 may train a model to have higher quantization accuracy than before within a minimal training time even if the learning data is not accessible (the learning data is not available).

The higher quantization accuracy may enable more accurate model inference on the external device 200 (e.g., mobile device). The model may have a lower number of quantization bits at the same accuracy to thus enable more efficient and faster AI model inference.

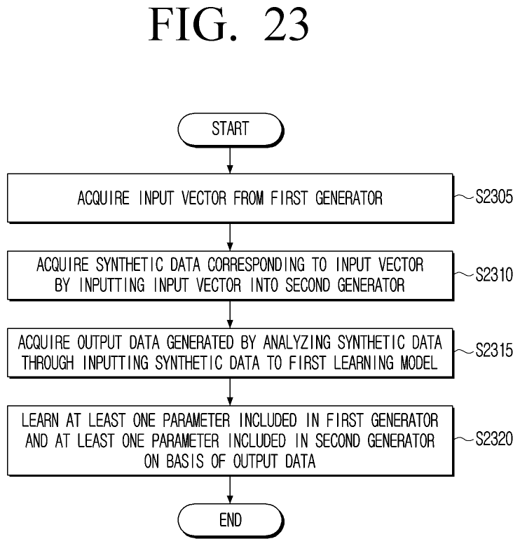

FIG. 23 is a diagram for describing a control method of an electronic device according to an embodiment of the disclosure.

Referring to FIG. 23, according to the various embodiments, provided is a control method of the electronic device, which stores a learning module including a first generator 141 that generates an input vector, a second generator 142 that generates synthetic data, and a first learning model that analyzes the synthetic data, the method including: obtaining the input vector from the first generator 141 at operation S2305; obtaining the synthetic data corresponding to the input vector by inputting the input vector into the second generator 142 at operation S2310; obtaining output data generated by analyzing the synthetic data through inputting the synthetic data to the first learning model at operation S2315; and learning at least one parameter included in the first generator 141 and at least one parameter included in the second generator 142 on the basis of the output data at operation S2320.

Meanwhile, in the learning at operation S2320, a loss value may be obtained on the basis of the output data, and at least one parameter included in the first generator 141 and at least one parameter included in the second generator 142 may be learned to minimize the loss value.

Meanwhile, the output data may include statistical feature data of the synthetic data.

Meanwhile, the output data may include the mean value and standard deviation value of the synthetic data, and in the obtaining of the loss value, a first difference value between the mean value of the synthetic data and a mean value of a batch normalization (BN) layer included in the first learning model may be obtained, a second difference value between the standard deviation value of the synthetic data and a standard deviation value of the batch normalization (BN) layer included in the first learning model may be obtained, and the loss value may be obtained on the basis of the first difference value and the second difference value.

Meanwhile, the control method may further include: obtaining stride data of at least one convolutional layer included in the first learning model; and replacing an identified convolutional layer with a swing convolution layer if the convolutional layer having a stride data size of 2 or more is identified among the at least one convolutional layer, wherein the swing convolution layer may be a convolutional layer that randomly selects a computation object on the basis of padding data.

Meanwhile, the swing convolution layer may be a layer that includes an operation for obtaining second data by adding the padding data to first data if the first data is input thereinto, an operation for obtaining third data by selecting some data regions from second data on the basis of a size of the first data, and an operation for performing convolution computation on the basis of the third data and kernel data of the identified convolutional layer.

Meanwhile, the first generator 141 may be a generator that generates a latent vector on the basis of at least one parameter, and at least one parameter included in the first generator 141 may be a parameter used to generate the synthetic data related to a target set by a user.

Meanwhile, the synthetic data may be image data related to the target set by the user.

Meanwhile, the control method may further include obtaining a second learning model by quantizing the first learning model, and the second learning model may be a compressed model of the first learning model.

Meanwhile, the control method may further include transmitting the second learning model to an external device.

Meanwhile, the control method of an electronic device as shown in FIG. 23 may be executed on the electronic device having the configuration in FIG. 2, and may also be executed on the electronic device having another configuration.

Meanwhile, the methods according to the various embodiments of the disclosure described above may be implemented in the form of an application capable of being installed in a conventional electronic device.

In addition, the methods according to the various embodiments of the disclosure described above may be implemented only by the software upgrade or hardware upgrade of the conventional electronic device.

In addition, the various embodiments of the disclosure described above may be performed through an embedded server included in the electronic device, or an external server of at least one of the electronic device and the display device.

Meanwhile, according to an embodiment of the disclosure, the various embodiments described above may be implemented by software including an instruction stored on a machine-readable storage medium (for example, a computer-readable storage medium). A machine may be a device that invokes the stored instruction from the storage medium, may be operated on the basis of the invoked instruction, and may include the electronic device according to the disclosed embodiments. If the instruction is executed by the processor, the processor may directly perform a function corresponding to the instruction or another component may perform the function corresponding to the instruction under the control of the processor. The instruction may include codes generated or executed by a compiler or an interpreter. The machine-readable storage medium may be provided in the form of a non-transitory storage medium. The term “non-transitory” only indicates that the storage medium is tangible without including a signal, and does not distinguish whether data are semi-permanently or temporarily stored on the storage medium.

In addition, according to an embodiment of the disclosure, the method according to the various embodiments described above may be provided by being included in a computer program product. The computer program product may be traded as a product between a seller and a purchaser. The computer program product may be distributed in a form of the machine-readable storage medium (for example, compact disc read only memory (CD-ROM)), or may be distributed online through an application store (for example, PlayStore™). In case of the online distribution, at least some of the computer program products may be at least temporarily stored on a storage medium such as memory of a server of a manufacturer, a server of an application store, or a relay server, or be temporarily generated.

In addition, each of the components (e.g., modules or programs) according to the various embodiments described above may include a single entity or a plurality of entities, and some of the corresponding sub-components described above may be omitted or other sub-components may be further included in the various embodiments. Alternatively or additionally, some of the components (e.g., modules or programs) may be integrated into the single entity, and may perform functions performed by the respective corresponding components before being integrated in the same or similar manner. Operations performed by the modules, the programs, or other components according to the various embodiments may be executed in a sequential manner, a parallel manner, an iterative manner, or a heuristic manner, at least some of the operations may be performed in a different order or be omitted, or other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory storing a learning module including a first generator that generates an input vector, a second generator that generates synthetic data, a first learning model that analyzes the synthetic data and one or more computer programs; and
one or more processors communicatively coupled to the memory,
wherein the one or more computer programs include computer-executable instructions that, when executed by the one or more processors individually or collectively, cause the electronic device to:
obtain the input vector from the first generator,
obtain the synthetic data corresponding to the input vector by inputting the input vector into the second generator,
obtain output data generated by analyzing the synthetic data through inputting the synthetic data into the first learning model, and
learn at least one parameter included in the first generator and at least one parameter included in the second generator on the basis of the output data.

2. The electronic device of claim 1, wherein the one or more computer programs further include computer-executable instructions that, when executed by the one or more processors individually or collectively, cause the electronic device to:
obtain a loss value on the basis of the output data, and
learn the at least one parameter included in the first generator and the at least one parameter included in the second generator to minimize the loss value.

3. The electronic device of claim 2, wherein the output data includes statistical feature data of the synthetic data.

4. The electronic device of claim 3,
wherein the output data includes a mean value and a standard deviation value of the synthetic data, and
wherein the one or more computer programs further include computer-executable instructions that, when executed by the one or more processors individually or collectively, cause the electronic device to:
obtain a first difference value between the mean value of the synthetic data and a mean value of a batch normalization (BN) layer included in the first learning model,
obtain a second difference value between the standard deviation value of the synthetic data and a standard deviation value of the batch normalization (BN) layer included in the first learning model, and
obtain the loss value on the basis of the first difference value and the second difference value.

5. The electronic device of claim 1,
wherein the one or more computer programs further include computer-executable instructions that, when executed by the one or more processors individually or collectively, cause the electronic device to:
obtain stride data of at least one convolutional layer included in the first learning model; and
replace an identified convolutional layer with a swing convolution layer if the convolutional layer having a stride data size of 2 or more is identified among the at least one convolutional layer, and
wherein the swing convolution layer is a convolutional layer that randomly selects a computation object on the basis of padding data.

6. The electronic device of claim 5, wherein the swing convolution layer is a layer that includes:
an operation for obtaining second data by adding the padding data to first data if the first data is input thereinto;
an operation for obtaining third data by selecting some data regions from the second data on the basis of a size of the first data; and
an operation for performing convolution computation on the basis of the third data and kernel data of the identified convolutional layer.

7. The electronic device of claim 1,
wherein the first generator is a generator that generates a latent vector on the basis of at least one parameter, and
wherein the at least one parameter included in the first generator is a parameter used to generate the synthetic data related to a target set by a user.

8. The electronic device of claim 1, wherein the synthetic data is image data related to a target set by a user.

9. The electronic device of claim 1,
wherein the one or more computer programs further include computer-executable instructions that, when executed by the one or more processors individually or collectively, cause the electronic device to obtain a second learning model by quantizing the first learning model, and
wherein the second learning model is a compressed model of the first learning model.

10. The electronic device of claim 9, further comprising:
a communication interface,
wherein the one or more computer programs further include computer-executable instructions that, when executed by the one or more processors individually or collectively, cause the electronic device to transmit the second learning model to an external device through the communication interface.

11. A method performed by an electronic device, which stores a learning module including a first generator that generates an input vector, a second generator that generates synthetic data, and a first learning model that analyzes the synthetic data, the method comprising:
obtaining, by the electronic device, the input vector from the first generator;
obtaining, by the electronic device, the synthetic data corresponding to the input vector by inputting the input vector into the second generator;
obtaining, by the electronic device, output data generated by analyzing the synthetic data through inputting the synthetic data into the first learning model; and
learning, by the electronic device, at least one parameter included in the first generator and at least one parameter included in the second generator on the basis of the output data.

12. The method of claim 11,
wherein in the learning, a loss value is obtained on the basis of the output data, and
wherein the at least one parameter included in the first generator and the at least one parameter included in the second generator are learned to minimize the loss value.

13. The method of claim 12, wherein the output data includes statistical feature data of the synthetic data.

14. The method of claim 13,
wherein the output data includes a mean value and a standard deviation value of the synthetic data, and
wherein the obtaining of the loss value includes:
a first difference value between the mean value of the synthetic data and a mean value of a batch normalization (BN) layer included in the first learning model is obtained;
a second difference value between the standard deviation value of the synthetic data and a standard deviation value of the batch normalization (BN) layer included in the first learning model is obtained; and
the loss value is obtained on the basis of the first difference value and the second difference value.

15. The method of claim 11, further comprising:
obtaining stride data of at least one convolutional layer included in the first learning model; and
replacing an identified convolutional layer with a swing convolution layer if the convolutional layer having a stride data size of 2 or more is identified among the at least one convolutional layer,
wherein the swing convolution layer is a convolutional layer that randomly selects a computation object on the basis of padding data.

16. The method of claim 15, wherein the swing convolution layer is a layer that includes:
an operation for obtaining second data by adding the padding data to first data if the first data is input thereinto;
an operation for obtaining third data by selecting some data regions from the second data on the basis of a size of the first data; and
an operation for performing convolution computation on the basis of the third data and kernel data of the identified convolutional layer.

17. The method of claim 16,
wherein the first generator is a generator that generates a latent vector on the basis of at least one parameter, and
wherein the at least one parameter included in the first generator is a parameter used to generate the synthetic data related to a target set by a user.

18. The method of claim 11, wherein the synthetic data is image data related to a target set by a user.

19. One or more non-transitory computer-readable storage media storing a learning module including a first generator that generates an input vector, a second generator that generates synthetic data, a first learning model that analyzes the synthetic data and one or more computer programs including computer-executable instructions that, when executed by one or more processors of an electronic device individually or collectively, cause the electronic device to perform operations, the operations comprising:
obtaining, by the electronic device, the input vector from the first generator;
obtaining, by the electronic device, the synthetic data corresponding to the input vector by inputting the input vector into the second generator;
obtaining, by the electronic device, output data generated by analyzing the synthetic data through inputting the synthetic data into the first learning model; and
learning, by the electronic device, at least one parameter included in the first generator and at least one parameter included in the second generator on the basis of the output data.

20. The one or more non-transitory computer-readable storage media of claim 19,
wherein in the learning, a loss value is obtained on the basis of the output data, and
wherein the at least one parameter included in the first generator and the at least one parameter included in the second generator are learned to minimize the loss value.
